(19) United States
(12) Patent Application Publication
(10) Pub. No.: US 2013/0108761 A1
(43) Pub. Date: May 2, 2013

(54) FUZZY DIAMOND GRILL FRYING PAN

(71) Applicant: Darlton Newton Kenton, Asheville, NC (US)

(72) Inventor: Darlton Newton Kenton, Asheville, NC (US)

(21) Appl. No.: 13/367,324

(22) Filed: Feb. 6, 2012

Related U.S. Application Data
(60) Provisional application No. 61/552,342, filed on Oct. 27, 2011.

(51) Int. Cl. A47J 37/10; A23L 1/01

(52) U.S. Cl. 426/523; 99/447

(57) ABSTRACT

A grill pan has a diamond grill forming at least a portion of its cooking surface. The diamond grill may provide a diamond grill pattern on cooked food products without having to turn the food products in a 45 degree angle to make a diamond pattern. The pan may have a diamond pattern raised from a bottom, heat application side of the pan. The pan may be made from cast iron, enamel coated cast iron, or stainless steel. In some embodiments, the pan may be made from cast iron containing from about 1.7 to about 4.5 percent carbon.

### CROSS-REFERENCE TO RELATED APPLICATIONS

This application claims the benefit of priority of U.S. provisional application No. 61/552,342, filed Oct. 27, 2011, the contents of which are herein incorporated by reference.

### BACKGROUND OF THE INVENTION

The present invention relates to cookware and, more particularly, to a grill pan with a small diamond grill formed on its cooking surface.

When grilling meats, seafood, vegetables, poultry, bread or cheese, for example, a cook has to rotate the food 45 degrees to make diamond grill marks on a conventional straight bar or slat grilling surface. This takes significant time in the cooking process. Moreover, accurate diamond shapes may be difficult to form, since turning exactly 45 degrees is required for a well-shaped diamond grill pattern. Finally, with the conventional grill surfaces, if the food product is left longer in one direction than the other, the grill pattern may show different intensities in each direction, reducing the presentation qualities of the food product to the consumer.

As can be seen, there is a need for an improved grilling surface for forming a diamond grill pattern on food products.

### SUMMARY OF THE INVENTION

In one aspect of the present invention, a grill pan comprises a grill surface side adapted to receive a food product there upon; a diamond grid disposed on the grill surface side; and a grill pan body surrounding the grill surface.

In another aspect of the present invention, a grill pan comprises a grill surface side adapted to receive a food product there upon; a bottom heat application side disposed opposite the grill surface side; a diamond grid disposed on the bottom heat application side; a grill pan body surrounding the grill surface; a handle attached to the grill pan body; and at least one drain on a side of the grill pan body.

In yet another aspect of the present invention, a method of forming a diamond sear on a food product comprises placing the food product in a grill pan, the grill pan comprising a grill surface side adapted to receive a food product there upon, a diamond grid disposed on the grill surface side, and a grill pan body surrounding the grill surface; applying heat to a bottom heat application side of the grill pan; and searing the food product along a contact sear point formed by the diamond grid.

These and other features, aspects and advantages of the present invention will become better understood with reference to the following drawings, description and claims.

### BRIEF DESCRIPTION OF THE DRAWINGS

FIG. 1 is a perspective view of a grill frying pan, in use, according to an exemplary embodiment of the present invention;

FIG. 2 is a perspective view of the grill frying pan of FIG. 1;

FIG. 3 is a bottom view of the grill frying pan of FIG. 1; and

FIG. 4 is a cross-sectional view taken along line 4-4 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a grill pan with a diamond grill forming at least a portion of its cooking surface. The diamond grill may provide a diamond grill pattern on cooked food products without having to turn the food products in a 45 degree angle to make a diamond pattern. The pan may have a diamond pattern raised from a bottom, heat application side of the pan. The pan may be made from cast iron, enamel coated cast iron, or stainless steel. In some embodiments, the pan may be made from cast iron containing from about 1.7 to about 4.5 percent carbon.

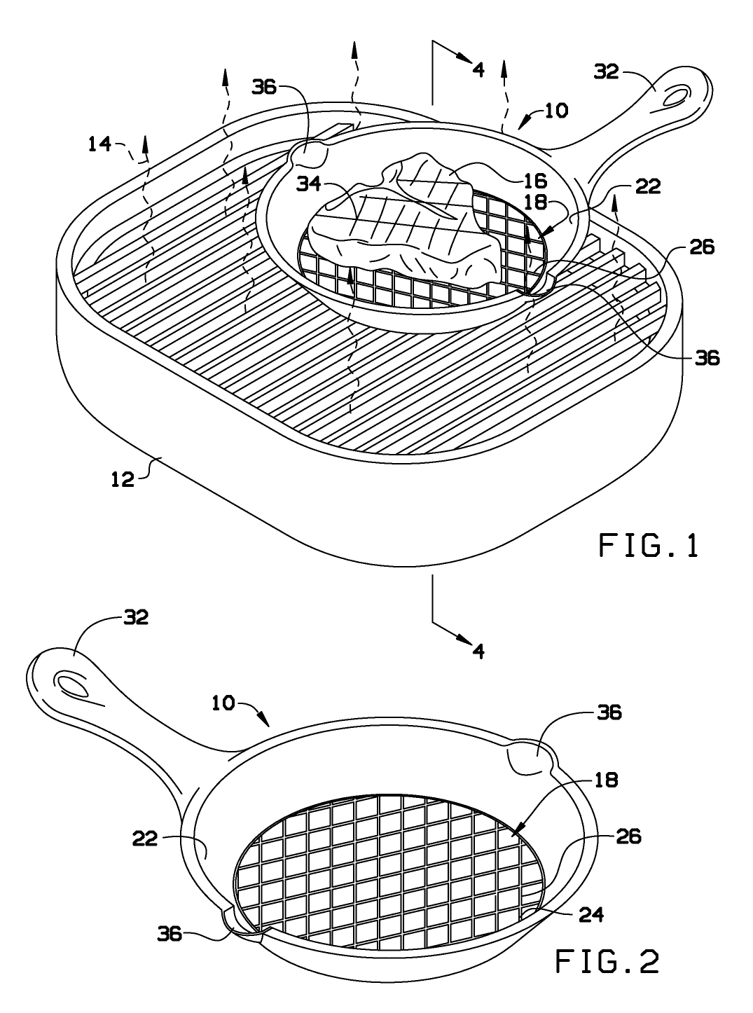

Referring now to FIGS. 1 through 4, a grill pan 10 may include a grill surface side 18 having a diamond grid 26 formed thereupon. The diamond grid 26 may be a raised surface forming a diamond shape. The diamond grid 26 may be made of the same material as the grill pan 10. The grill pan 10 may be made from, for example, cast iron, enamel coated cast iron, or stainless steel. In some embodiments, the grill pan 10 may be made of cast iron containing from about 1.7 to about 4.5 percent carbon. Such a material may be brittle and may not be capable of being wrought, but must be shaped by casting.

In some embodiments, the grill pan 10 may include a cast iron body 22 having an enamel coating 24 thereupon. The enamel coating 24 may help prevent rusting of the cast iron. The grill pan 10 may include a handle 32 and one or more drains 36 formed in the body 22.

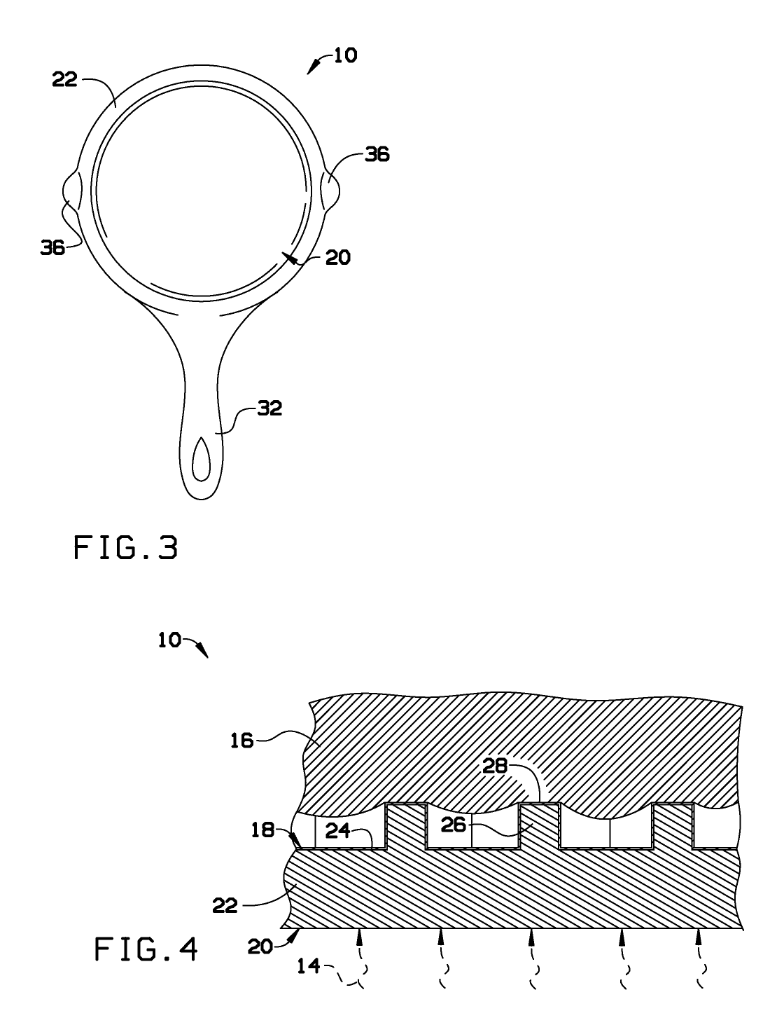

Referring to FIG. 3, the diamond grid 26 (see FIG. 2) may be disposed on a bottom heat application side 20 of the grill pan 10. In some embodiments, as shown in FIG. 3, the bottom heat application side 20 is a solid surface, typically made integral with the grill pan 10. In other embodiments, the bottom heat application side 20 may include holes for draining fluid therethrough.

Referring now to FIGS. 1 and 4, an exemplary grill item 16 may be placed in the grill pan 10 and the grill pan 10 placed in a heat stream 14 (or the grill pan 10 may be preheated on the heat stream 14 before the grill item 16 is placed in the grill pan 10, for example). The heat stream 14 may be any source of heat typically used for cooking. The grill item 16 may be any food product where a diamond shaped sear marking 34 is desired. As shown in detail in FIG. 4, the diamond grid 26 may create a plurality of contact sear points 28 for searing the diamond grid 26 into the grill item 16.

The size of the diamond grid 26 may vary according to the user's desired presentation. The diamond grid 26 may be additionally designed into an electric grill or barbeque grill, branding iron to create sear marks on a food product. In some embodiments, the diamond grid 26 may be incorporated in other cookware, such as a grill press, a flat top grill, or the like.

It should be understood, of course, that the foregoing relates to exemplary embodiments of the invention and that modifications may be made without departing from the spirit and scope of the invention as set forth in the following claims.

What is claimed is:

1. A grill pan comprising:
a grill surface side adapted to receive a food product there upon;
a diamond grid disposed on the grill surface side; and
a grill pan body surrounding the grill surface.

2. The grill pan of claim 1, further comprising a bottom heat application side disposed opposite the grill surface side.

3. The grill pan of claim 1, further comprising a handle attached to the grill pan body.

4. The grill pan of claim 1, further comprising at least one drain on a side of the grill pan body.

5. The grill pan of claim 1, wherein the grill pan is made of cast iron.

6. The grill pan of claim 5, wherein the cast iron includes from about 1.7 to about 4.5 percent carbon.

7. A grill pan comprising:
a grill surface side adapted to receive a food product there upon;
a bottom heat application side disposed opposite the grill surface side;
a diamond grid disposed on the bottom heat application side;
a grill pan body surrounding the grill surface;
a handle attached to the grill pan body; and
at least one drain on a side of the grill pan body.

8. The grill pan of claim 7, wherein the grill pan is made of cast iron having from about 1.7 to about 4.5 percent carbon.

9. A method of forming a diamond sear on a food product, the method comprising:
placing the food product in a grill pan, the grill pan comprising a grill surface side adapted to receive a food product there upon, a diamond grid disposed on the grill surface side, and a grill pan body surrounding the grill surface;
applying heat to a bottom heat application side of the grill pan; and
searing the food product along a contact sear point formed by the diamond grid.

10. The method of claim 9, further comprising turning the food product to sear a similar diamond sear pattern on a second side of the food product.
